(19) United States
(12) Patent Application Publication
(10) Pub. No.: US 2019/0179598 A1
(43) Pub. Date: Jun. 13, 2019

(54) SUGGESTIVE PREEMPTIVE RADIO TURNER

(71) Applicant: Panasonic Automotive Systems Company of America Division of Panasonic Corporation of North America, Peachtree City, GA (US)

(72) Inventor: ERIC SHUFRO, PEACHTREE CITY, GA (US)

(21) Appl. No.: 16/190,215

(22) Filed: Nov. 14, 2018

Related U.S. Application Data
(60) Provisional application No. 62/597,181, filed on Dec. 11, 2017.

(51) Int. Cl. G06F 3/16; H04R 1/02; B60R 16/037

(52) U.S. Cl. CPC G06F 3/165; H04R 1/025; H04R 2499/13; G06F 3/167; B60R 16/0373

(57) ABSTRACT

An audio system in a motor vehicle includes a loudspeaker, a first tuner, a second tuner and an electronic processor. The first tuner tunes to a first frequency such that content broadcasted on the first frequency is played on the loudspeaker. The second tuner tunes to a second frequency while the first tuner tunes to the first frequency and the content broadcasted on the first frequency is played on the loudspeaker. The electronic processor ascertains a user's preferences for content based upon inputs received from the user before the first tuner tunes to the first frequency. The electronic processor determines, based on the user's ascertained preferences, that the user prefers content being broadcast on the second frequency to the content being broadcast on the first frequency. In response to the determining, the electronic processor begins playing the content being broadcast on the second frequency on the loudspeaker.

### CROSS-REFERENCED TO RELATED APPLICATIONS

This application claims benefit of U.S. Provisional Application No. 62/597,181 filed on Dec. 11, 2017, which the disclosure of which is hereby incorporated by reference in its entirety for all purposes.

### FIELD OF THE INVENTION

The disclosure relates to a smart radio tuner in a motor vehicle.

### BACKGROUND OF THE INVENTION

A user of a car radio must frequently use the Seek and/or Scan pushbuttons in order to find broadcasted content that he wants to listen to. This can be a tedious process, and may take a driver's attention away from the driving task.

### SUMMARY

The present invention may provide a smart radio tuner capable of background scanning radio or satellite stations, and capturing station RDS or song tag information. The currently playing information may be displayed by the human machine interface (HMI) as alternative or preferred listening suggestions, perhaps with a heading such as: “Also Playing” or some text chosen by the customer.

A settings option for preemptive tuning may be available such that the application detects less preferable listening content, such as commercials, and displays a configurable time count down timer on the HMI. If the down counter reaches 0, the head unit may preemptively switch to preferred content. The down counter can be aborted by a pre-determined steering wheel key press or voice command. An auditory beep may be enabled to indicate the start of the preemptive down counter.

The inventive radio may utilize machine learning or another mechanism to learn each car user's content preference. A “thumbs up” or “thumbs down” HMI element, voice commands (active indications) or the amount of time tuned to a given station with consideration of what is playing (passive indications) may be used by the user to actively indicate his preference toward a particular type of content. Over time, the radio may be able to predictively rank and suggest content as per the user's past history and listening preferences.

Ranking of content can be performed either via machine learning or via existing industry methods for tagging and “liking” content. The more “likes” the user makes, the more preferences can be determined.

The HMI may display the ranking criteria next to the suggested entries to provide clarity to the preemptive tuning decision-making process.

If the user chooses to jump to one of the “Also Playing” stations via voice or HMI touch, then the content on the currently tuned-to station may be automatically down ranked.

In one embodiment, the invention comprises an audio system in a motor vehicle including a loudspeaker, a first tuner, a second tuner and an electronic processor. The first tuner tunes to a first frequency such that content broadcasted on the first frequency is played on the loudspeaker. The second tuner tunes to a second frequency while the first tuner tunes to the first frequency and the content broadcasted on the first frequency is played on the loudspeaker. The electronic processor is communicatively coupled to the first tuner, to the second tuner, and to the loudspeaker. The electronic processor ascertains a user's preferences for content based upon inputs received from the user before the first tuner tunes to the first frequency. The electronic processor determines, based on the user's ascertained preferences, that the user prefers content being broadcast on the second frequency to the content being broadcast on the first frequency. In response to the determining, the electronic processor ceases playing the content being broadcast on the first frequency on the loudspeaker and begins playing the content being broadcast on the second frequency on the loudspeaker.

In another embodiment, the invention comprises a method of operating a radio in a motor vehicle, including receiving inputs from a user before any other step of the method. A first frequency is tuned to such that content broadcasted on the first frequency is played on a loudspeaker within the motor vehicle. A second frequency is tuned to while the first tuner tunes to the first frequency, and while the content broadcasted on the first frequency is played on the loudspeaker. A user's preferences for content are ascertained based upon the inputs received from the user. It is determined, based on the user's ascertained preferences, that the user prefers content being broadcast on the second frequency to the content being broadcast on the first frequency. In response to the determining, the playing of the content being broadcast on the first frequency on the loudspeaker is ceased, and the content being broadcast on the second frequency on the loudspeaker is begun to be played on the loudspeaker.

In yet another embodiment, the invention comprises an audio system in a motor vehicle, including a loudspeaker, a first tuner, a second tuner, a user interface, and an electronic processor. The first tuner tunes to a first frequency such that content broadcasted on the first frequency is played on the loudspeaker. The second tuner tunes to a second frequency while the first tuner tunes to the first frequency and the content broadcasted on the first frequency is played on the loudspeaker. The user interface receives inputs from a user. The electronic processor is communicatively coupled to the first tuner, to the second tuner, to the loudspeaker, and to the user interface. The electronic processor ascertains a user's preferences for content based upon inputs received from the user via the user interface. The electronic processor determines, based on the user's ascertained preferences, that the user prefers content being broadcast on the second frequency to the content being broadcast on the first frequency. In response to the determining, the electronic processor informs the user that the radio will cease playing on the loudspeaker the content being broadcast on the first frequency and will begin playing the content being broadcast on the second frequency on the loudspeaker. In response to receiving a command from the user via the user interface after the informing and while the content being broadcast on the first frequency is still being played on the loudspeaker, the electronic processor continues to play the content being broadcast on the first frequency on the loudspeaker, and inhibits the playing of the content being broadcast on the second frequency on the loudspeaker.

The invention may have the advantage of reducing the need for users to “seek” or radio channel surf. Thus, the inventive radio may save time and provide a better user experience.

### BRIEF DESCRIPTION OF THE DRAWINGS

A better understanding of the present invention will be had upon reference to the following description in conjunction with the accompanying drawings.

FIG. 1 is a plan view of one embodiment of a user interface of a radio of the present invention.

FIG. 2 is a block diagram of one embodiment of an audio system of the present invention for a motor vehicle.

FIG. 3 is a flow chart of one embodiment of a method of the present invention for operating a radio in a motor vehicle.

### DETAILED DESCRIPTION OF THE PREFERRED EMBODIMENTS

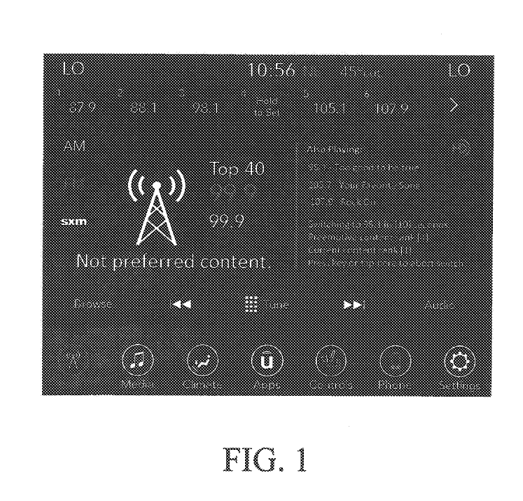

FIG. 1 illustrates one embodiment of a user interface of a radio of the present invention, including a touch-sensitive display screen. On the left-hand side of the display screen it is indicated that the radio is currently tuned to a frequency of 99.9 MHz, which plays top 40 type music and is not currently playing content that is preferred by the listener, based on the listener's previous active and passive indications of his preferences.

On the right-hand side of the display screen it is indicated that the radio tuner in the background has determined the currently broadcasted content on three other radio stations. These three other radio stations are shown to broadcast at frequencies of 98.1 MHz, 105.7 MHz and 107.9 MHz. The title of the song currently playing on each of these three radio stations is also displayed on the right-hand side of the display screen.

The right-hand side of the display screen further discloses that the radio will preemptively switch to the 98.1 MHz frequency in ten seconds. The content being broadcast by the 98.1 MHz frequency is indicated to be ranked by the radio with the highest score of 4 out of the four stations currently being considered. Thus, the radio may preemptively switch to the 98.1 MHz frequency because this frequency has the highest ranking out of the four stations currently being considered. The content being broadcast by the currently tuned-to frequency of 99.9 MHz is indicated to be ranked by the radio with the lowest score of 1 out of the four stations currently being considered.

The other two frequencies of 105.7 MHz and 107.9 MHz may be inferred by the user to be broadcasting content that is ranked by the radio with the remaining possible scores of 2 and 3 out of the four stations currently being considered, although the user may not be able to discern which of these two frequencies is associated with the score of 2 and which is associated with the score of 3. It is possible for the display screen to indicate which station has the ranking of 2 and which has the ranking of 3.

Lastly, it is indicated on the right-hand side of the display screen that the user can abort the preemptive switch to the frequency of 98.1 MHz by touching any touch-sensitive pushbutton on the display screen or by touching the display screen in the area labeled “here” or thereabouts.

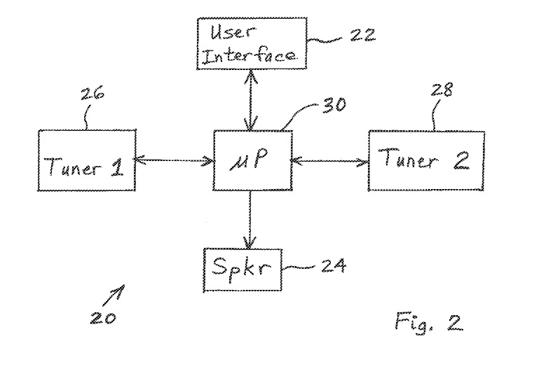

FIG. 2 illustrates one embodiment of an audio system 20 of the present invention for a motor vehicle, including a user interface 22, a loudspeaker 24, a first tuner 26, a second tuner 28, and an electronic processor 30. User interface 22 may include the display screen of FIG. 1 as well as a microphone and dials.

First tuner 26 may tune to a first frequency such that content broadcasted on the first frequency is played on loudspeaker 24. A second tuner 28 may tune to a second frequency in the background while first tuner 26 tunes to the first frequency and the content broadcasted on the first frequency is played on loudspeaker 24.

Electronic processor 30 is communicatively coupled to user interface 22, first tuner 26, second tuner 28, and loudspeaker 24. Electronic processor 30 ascertains a user's preferences for content based upon inputs received from the user before the first tuner tunes to the first frequency. Electronic processor 30 may determine, based on the user's ascertained preferences, that the user prefers content being broadcast on the second frequency to the content being broadcast on the first frequency. In response to the determining that the user prefers content being broadcast on the second frequency, electronic processor 30 may cease playing the content being broadcast on the first frequency on loudspeaker 24 and may begin playing the content being broadcast on the second frequency on loudspeaker 24.

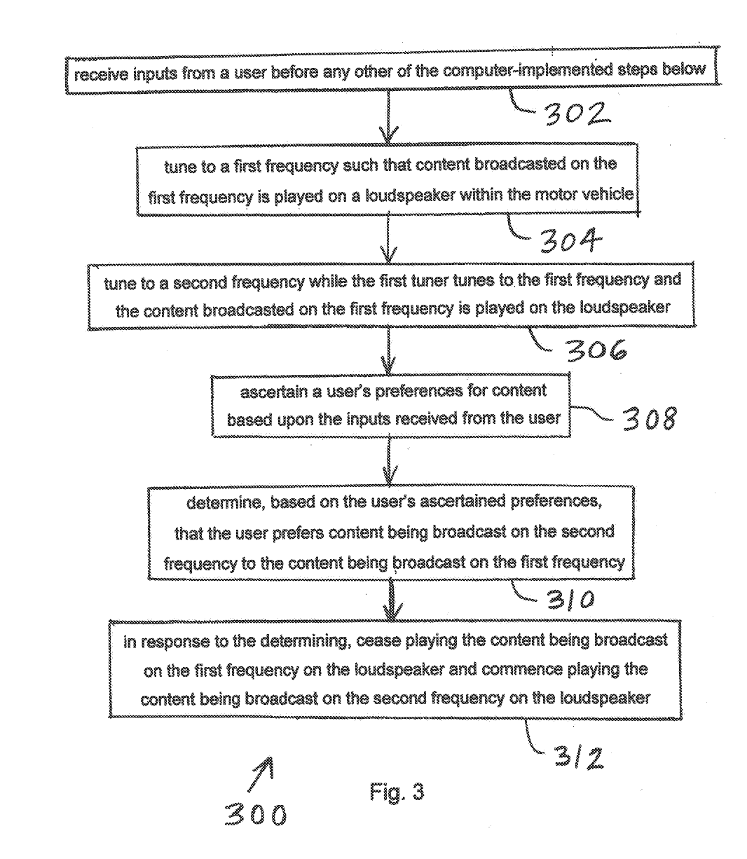

FIG. 3 illustrates one embodiment of a method 300 of the present invention for operating a radio in a motor vehicle. The method includes the following computer-implemented steps. In a first such step 302, inputs are receiver from a user. For example, the listener's active and passive indications of his preferences may be received. The listener's active indications of his preferences may include the listener pressing a “like” pushbutton on user interface 22 when listening to a certain type of song, or switching to other content when a certain type of song is playing. The listener's passive indications of his preferences may include the listener continuing to listen to a certain type of song when it is playing, rather than switching to other content. The inputs may also include the listener loading certain types of songs that he presumably prefers into audio system 20.

Next, in step 304, a first frequency is tuned to such that content broadcasted on the first frequency is played on a loudspeaker within the motor vehicle. For example, when the car radio is turned on, the radio may automatically tune to a certain frequency in the FM band by use of a first tuner 26, and the content being broadcast on that frequency is played on a loudspeaker 24 in the car.

In a next step 306, a second frequency is tuned to by a second tuner while the first tuner tunes to the first frequency and the content broadcasted on the first frequency is played on the loudspeaker. For example, a second tuner 28 may operate in the background while first tuner 26 is also operating, and while the content from the frequency to which first tuner 26 is tuned is being audibly played on loudspeaker 24. Second tuner 28 may tune to a radio station that first tuner 26 is not tuned to.

In step 308, a user's preferences for content are ascertained based upon the inputs received from the user. For example, processor 30 may ascertain what types of music the user likes based on the inputs received from the user in step 302.

Next, in step 310, it is determined, based on the user's ascertained preferences, that the user prefers content being broadcast on the second frequency to the content being broadcast on the first frequency. For example, processor 30 may analyze metadata in the signals broadcast on the two frequencies to determine which of the two frequencies is broadcasting a type of audio content that the user likes more, based on the user's preferences ascertained in step 308. It may be determined that the user likes the content on the second frequency more than the content on the first frequency.

In a final step 312, in response to the determining, playing of the content being broadcast on the first frequency on the loudspeaker is ceased, and playing of the content being broadcast on the second frequency on the loudspeaker is commenced. For example, processor 30 may stop playing the content on the frequency tuned to by first tuner 26, and may begin playing the content on the frequency tuned to by second tuner 28.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An audio system in a motor vehicle, the audio system comprising:
a loudspeaker;
a first tuner configured to tune to a first frequency such that content broadcasted on the first frequency is played on the loudspeaker;
a second tuner configured to tune to a second frequency while the first tuner tunes to the first frequency and the content broadcasted on the first frequency is played on the loudspeaker;
an electronic processor communicatively coupled to the first tuner, to the second tuner, and to the loudspeaker, the electronic processor being configured to:
ascertain a user's preferences for content based upon inputs received from the user before the first tuner tunes to the first frequency;
determine, based on the user's ascertained preferences, that the user prefers content being broadcast on the second frequency to the content being broadcast on the first frequency; and
in response to the determining, cease playing the content being broadcast on the first frequency on the loudspeaker and begin playing the content being broadcast on the second frequency on the loudspeaker.

2. The audio system of claim 1 wherein the inputs received from the user comprise the user indicating which content he likes and which content he dislikes.

3. The audio system of claim 1 wherein the inputs received from the user comprise the user providing voice commands.

4. The audio system of claim 1 wherein the inputs received from the user comprise the user switching from first content to second content and a length of time that the user continues to listen to the second content.

5. The audio system of claim 1 further comprising a user interface communicatively coupled to the electronic processor, the user interface including means for enabling the user to switch content being played on the loudspeaker, wherein the inputs are received from the user via the enabling means of the user interface.

6. The audio system of claim 1 further comprising a user interface communicatively coupled to the electronic processor, the user interface being configured to inform the user at what point in time in the future that the content being broadcast on the first frequency will cease being played on the loudspeaker and the content being broadcast on the second frequency will begin being played on the loudspeaker.

7. The audio system of claim 1 further comprising a user interface communicatively coupled to the electronic processor, the user interface being configured to inform the user of relative rankings of the respective content of at least three broadcast frequencies in terms of the user's ascertained preferences.

8. A method of operating a radio in a motor vehicle, the method comprising:
receiving inputs from a user before any other step of the method;
tuning to a first frequency with a first tuner such that content broadcasted on the first frequency is played on a loudspeaker within the motor vehicle;
tuning to a second frequency with a second tuner while the first tuner tunes to the first frequency and the content broadcasted on the first frequency is played on the loudspeaker;
ascertaining a user's preferences for content based upon the inputs received from the user;
determining, based on the user's ascertained preferences, that the user prefers content being broadcast on the second frequency to the content being broadcast on the first frequency; and
in response to the determining, ceasing playing the content being broadcast on the first frequency on the loudspeaker and commencing playing the content being broadcast on the second frequency on the loudspeaker.

9. The method of claim 8 wherein the inputs received from the user comprise the user indicating which content he likes and which content he dislikes.

10. The method of claim 8 wherein the inputs received from the user comprise the user providing voice commands.

11. The method of claim 8 wherein the inputs received from the user comprise:
the user switching from first content to second content; and
a length of time that the user continues to listen to the second content.

12. The method of claim 8 further comprising enabling the user to switch content being played on the loudspeaker via a same means by which the user provides the inputs.

13. The method of claim 8 further comprising informing the user at what point in time in the future that the content being broadcast on the first frequency will cease being played on the loudspeaker and the content being broadcast on the second frequency will begin being played on the loudspeaker.

14. The method of claim 8 further comprising informing the user of relative rankings of the respective content of at least three broadcast frequencies in terms of the user's ascertained preferences.

15. An audio system in a motor vehicle, the audio system comprising:
a loudspeaker;
a first tuner configured to tune to a first frequency such that content broadcasted on the first frequency is played on the loudspeaker;
a second tuner configured to tune to a second frequency while the first tuner tunes to the first frequency and the content broadcasted on the first frequency is played on the loudspeaker;
a user interface configured to receive inputs from a user;
an electronic processor communicatively coupled to the first tuner, to the second tuner, to the loudspeaker, and to the user interface, the electronic processor being configured to:
ascertain a user's preferences for content based upon inputs received from the user via the user interface;
determine, based on the user's ascertained preferences, that the user prefers content being broadcast on the second frequency to the content being broadcast on the first frequency;
in response to the determining, inform the user that the radio will cease playing the content being broadcast on the first frequency on the loudspeaker and begin playing the content being broadcast on the second frequency on the loudspeaker; and
in response to receiving a command from the user via the user interface after the informing and while the content being broadcast on the first frequency is still being played on the loudspeaker, continue to play the content being broadcast on the first frequency on the loudspeaker, and inhibit the playing of the content being broadcast on the second frequency on the loudspeaker.

16. The audio system of claim 15, wherein the electronic processor is configured to ascertain a user's preferences for content based upon inputs received from the user during previous listening sessions.

17. The audio system of claim 15, wherein the electronic processor is configured to ascertain a user's preferences for content based upon inputs received from the user more than fifteen seconds before the ascertaining of the user's preferences begins.

18. The audio system of claim 15, wherein the user interface comprises a touch-sensitive display screen.

19. The audio system of claim 15, wherein the electronic processor is configured to in response to the determining, inform the user that the radio will cease playing the content being broadcast on the first frequency on the loudspeaker at a certain number of seconds in the future and begin playing the content being broadcast on the second frequency on the loudspeaker at the certain number of seconds in the future.

20. The audio system of claim 15, wherein the second tuner configured to tune to a plurality of second frequencies while the first tuner tunes to the first frequency and the content broadcasted on the first frequency is played on the loudspeaker, and the electronic processor is configured to indicate to the user via the user interface relative rankings of the content of the first frequency and the second frequencies in terms of the user's preferences.
